(19) United States
(12) Patent Application Publication
(10) Pub. No.: US 2026/0180245 A1
(43) Pub. Date: Jun. 25, 2026

(54) MODULAR JACK

(71) Applicant: J.S.T. Mfg. Co., Ltd., Tokyo (JP)

(72) Inventor: Masaki TSUJIMOTO, Yokohama-shi (JP)

(73) Assignee: J.S.T. Mfg. Co., Ltd., Tokyo (JP)

(21) Appl. No.: 19/429,623

(22) Filed: Dec. 22, 2025

(30) Foreign Application Priority Data
Dec. 23, 2024 (JP) 2024-226770

(51) Int. Cl. H01R 13/627; H01R 13/506; H01R 13/631

(52) U.S. Cl. CPC H01R 13/6272; H01R 13/506; H01R 13/631; H01R 2201/04

(57) ABSTRACT

A modular jack is electrically connected to a plug that includes a plug body having a cable, a mating contact provided on the plug body, a latch portion elastically deformable to pivot toward the plug body around one end portion provided on the plug body, and a lever portion provided on the latch portion. The modular jack includes a housing into which the plug is inserted, a contact connected to the mating contact, and a shell to which the latch portion can latch so as to prevent the plug inserted into the housing from being detached from the housing. The shell includes an anti-lift portion configured to prevent the latch portion from pivoting away from the plug body to an extent that the latch portion becomes unable to latch to the shell.

This application is based on and claims the benefit of priority from Japanese Patent Application No. 2024-226770, filed on 23 Dec. 2024, the content of which is incorporated herein by reference.

### BACKGROUND OF THE INVENTION

### Field of the Invention

The present invention relates to a modular jack, and more particularly to a modular jack to which a modular plug used for a local area network (LAN) cable is connected.

### Related Art

Patent Document 1 discloses a modular jack, to which a telecommunication plug is electrically connected. This modular jack includes an insulating housing including a plug-receiving opening, into which the telecommunication plug is inserted. A pair of lip portions extending inward are formed on both sidewalls of the insulating housing. When the telecommunication plug is attached to the modular jack with such a configuration, and the telecommunication plug is inserted into the plug-receiving opening of the insulating housing, a latch arm of the telecommunication plug is engaged with the pair of lip portions of the insulating housing. This engagement prevents the telecommunication plug from being detached from the insulating housing.

Patent Document 1: Japanese Unexamined Patent Application, Publication No. 2000-268921

### SUMMARY OF THE INVENTION

In the conventional modular jack, in a state where a telecommunication plug is attached to an insulating housing, the latch arm of the telecommunication plug is engaged with a side end portion on a rear side of a pair of lip portions. In a state where the latch arm of the telecommunication plug is engaged with the lip portions, if the telecommunication plug is forcibly pulled out from the insulating housing, the latch arm may ride over the lip portions. That is, the lip portions of the insulating housing may enter between the latch arm of the telecommunication plug and a body of the telecommunication plug. In such a state, the latch arm cannot be operated, and therefore, the telecommunication plug cannot be removed from the insulating housing.

Weight reduction of an electronic device such as a notebook computer, to which a modular jack is applied, is desirable from the viewpoint of improving portability. Such weight reduction of the electronic device may be achieved, for example, by devising a configuration of the modular jack. Accordingly, a lighter modular jack is desired.

An object of the present invention is to provide a modular jack having a simple structure that can prevent a modular plug from becoming undetachable from the modular jack.

The inventors of the present invention conceived that, in a modular jack to which a modular plug is latched, the above problem can be solved by adopting a configuration that prevents the portion of the modular plug latched to the modular jack from pivoting upward more than necessary. Based on this finding, the inventors completed the following novel modular jack.
(1) A modular jack according to the present invention is a modular jack to which a modular plug is electrically connected. The modular plug includes a plug body having a cable, a mating contact provided on the plug body, a latch portion elastically deformable to pivot toward the plug body around one end portion provided on the plug body, and a lever portion provided on the latch portion. The modular jack includes: a housing, into which the modular plug is configured to be inserted; a contact provided on the housing and connected to the mating contact; and a shell provided on the housing so as to cover an outer surface of the housing, the shell, to which the latch portion can be latched so as to prevent the modular plug inserted into the housing from being detached from the housing, in which the shell includes an anti-lift portion configured to prevent the latch portion from pivoting away from the plug body to an extent that the latch portion becomes unable to latch to the shell.
(2) In the modular jack as described in item (1), in a state where the latch portion can latch to the shell, the latch portion is preferably not in contact with the anti-lift portion, and when the latch portion comes into contact with the anti-lift portion, the latch portion is preferably prevented from pivoting away from the plug body to an extent that the latch portion becomes unable to latch to the shell.
(3) In the modular jack as described in item (2), the shell preferably includes a shell body including a hole portion that allows the latch portion and the lever portion to protrude outward, and the anti-lift portion provided on the shell body and allowing the latch portion to latch to the anti-lift portion. The anti-lift portion is preferably disposed so as to extend across the hole portion.
(4) In the modular jack as described in item (1), in a state where the latch portion can latch to the shell, the latch portion is preferably in contact with the anti-lift portion so as to prevent the latch portion from pivoting away from the plug body.
(5) In the modular jack as described in item (4), the shell preferably includes a shell body including a hole portion to which the latch portion can be latched, and the anti-lift portion provided on the shell body. The hole portion preferably allows the latch portion and the lever portion to protrude outward, and the anti-lift portion is preferably disposed so as to extend across the hole portion.

The present invention provides a configuration of a modular jack to which a modular plug is latched, in which a portion of a modular plug latched to the modular jack is prevented from pivoting upward more than necessary. Accordingly, it is possible to provide a modular jack having a simple structure that can prevent a modular plug from becoming undetachable from the modular jack.

### BRIEF DESCRIPTION OF THE DRAWINGS

FIG. 1 is a perspective view illustrating a usage state of a modular jack according to a first embodiment of the present invention;

FIG. 2 is a longitudinal sectional view illustrating a usage state of the modular jack according to the first embodiment of the present invention;

FIG. 3 is a perspective view illustrating the modular jack according to the first embodiment of the present invention as viewed from the front side;

FIG. 4 is a perspective view illustrating the modular jack according to the first embodiment of the present invention as viewed from the rear side;

FIG. 5 is an exploded perspective view illustrating the modular jack according to the first embodiment of the present invention as viewed from above;

FIG. 6 is an exploded perspective view illustrating the modular jack according to the first embodiment of the present invention as viewed from below;

FIG. 7 is a right side view illustrating a shell of the modular jack according to the first embodiment of the present invention;

FIG. 8 is a plan view illustrating the shell of the modular jack according to the first embodiment of the present invention;

FIG. 9 is a front view illustrating a housing of the modular jack according to the first embodiment of the present invention;

FIG. 10 is a rear view illustrating the housing of the modular jack according to the first embodiment of the present invention;

FIG. 11 is a plan view illustrating the housing of the modular jack according to the first embodiment of the present invention;

FIG. 12 is a perspective view illustrating a modular plug connected to the modular jack according to the first embodiment of the present invention as viewed from above;

FIG. 13 is a perspective view illustrating the modular plug connected to the modular jack according to the first embodiment of the present invention as viewed from below;

FIG. 14 is a right side view illustrating the modular plug connected to the modular jack according to the first embodiment of the present invention;

FIG. 15 is a perspective view illustrating a usage state of a modular jack according to a second embodiment of the present invention;

FIG. 16 is a longitudinal sectional view illustrating a usage state of the modular jack according to the second embodiment of the present invention;

FIG. 17 is a perspective view illustrating the modular jack according to the second embodiment of the present invention;

FIG. 18 is an exploded perspective view illustrating the modular jack according to the second embodiment of the present invention;

FIG. 19 is a front view illustrating a shell of the modular jack according to the second embodiment of the present invention;

FIG. 20 is a right side view illustrating the shell of the modular jack according to a second embodiment of the present invention;

FIG. 21 is a plan view illustrating the shell of the modular jack according to the second embodiment of the present invention;

FIG. 22 is a bottom view illustrating the shell of the modular jack according to the second embodiment of the present invention;

FIG. 23 is a perspective view illustrating a usage state of a modular jack according to a third embodiment of the present invention;

FIG. 24 is a longitudinal sectional view illustrating a usage state of the modular jack according to the third embodiment of the present invention;

FIG. 25 is a perspective view illustrating the modular jack according to the third embodiment of the present invention;

FIG. 26 is an exploded perspective view illustrating the modular jack according to the third embodiment of the present invention;

FIG. 27 is a front view illustrating a shell of the modular jack according to the third embodiment of the present invention;

FIG. 28 is a right side view illustrating the shell of the modular jack according to the third embodiment of the present invention;

FIG. 29 is a plan view illustrating the shell of the modular jack according to the third embodiment of the present invention;

FIG. 30 is a perspective view illustrating a usage state of a modular jack according to a fourth embodiment of the present invention;

FIG. 31 is a longitudinal sectional view illustrating a usage state of the modular jack according to the fourth embodiment of the present invention;

FIG. 32 is a perspective view illustrating the modular jack according to the fourth embodiment of the present invention;

FIG. 33 is an exploded perspective view illustrating the modular jack according to the fourth embodiment of the present invention;

FIG. 34 is a front view illustrating a shell of the modular jack according to the fourth embodiment of the present invention;

FIG. 35 is a plan view illustrating the shell of the modular jack according to the fourth embodiment of the present invention; and

FIG. 36 is a bottom view illustrating the shell of the modular jack according to the fourth embodiment of the present invention.

### DETAILED DESCRIPTION OF THE INVENTION

Hereinafter, embodiments for carrying out the present invention will be described with reference to the drawings.

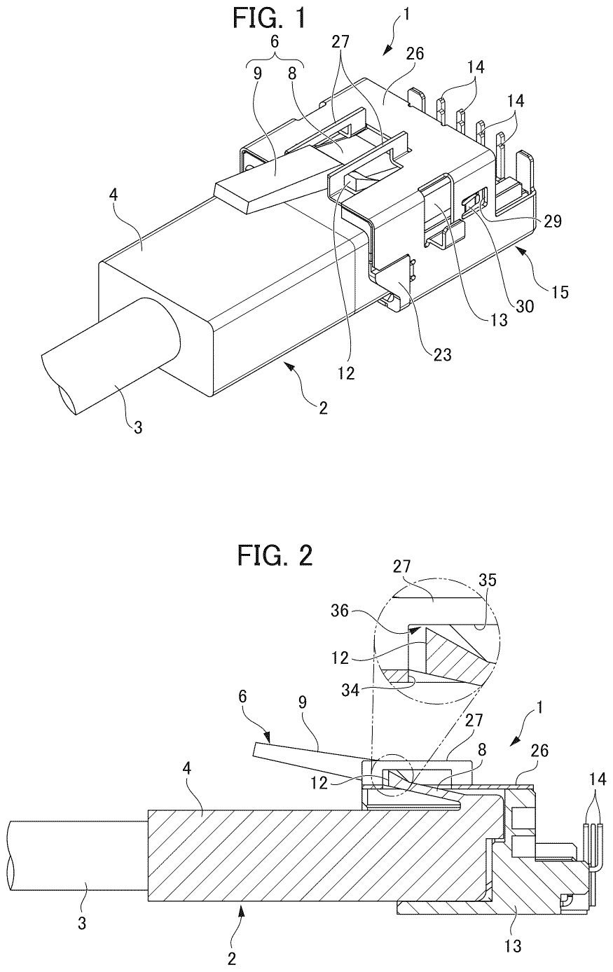

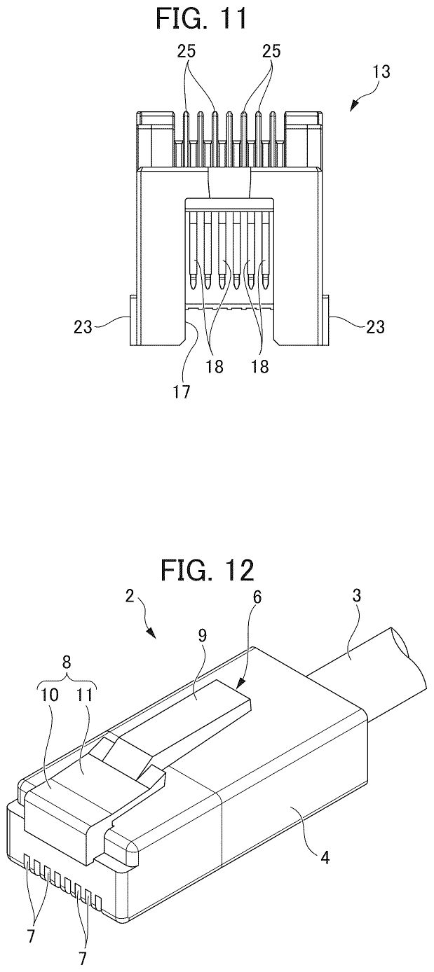

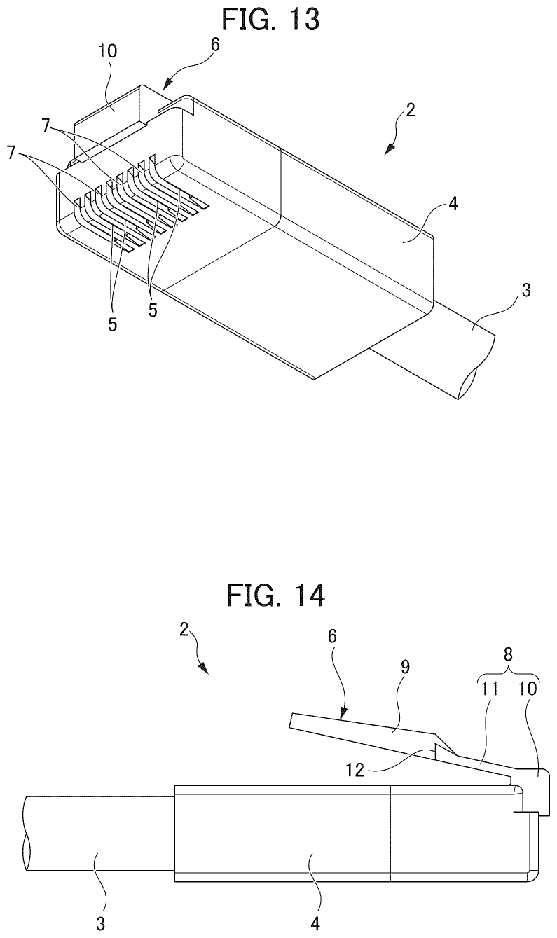

As illustrated in FIGS. 1 and 2, a modular plug 2 is electrically connected to a modular jack 1 according to a first embodiment of the present invention. The modular plug 2 is detachably attached to the modular jack 1. As illustrated in FIGS. 12 to 14, the modular plug 2 is a conventionally known plug typically used for a local area network (LAN) cable, and includes a plug body 4 including a cable 3, a mating contact 5 provided on the plug body 4, and a lock lever 6 provided on the plug body 4. In this specification, a direction in which the modular plug 2 is inserted into and withdrawn from the modular jack 1 is defined as a front-rear direction; and a direction perpendicular to both the vertical direction and the front-rear direction is defined as a left- right direction. In the front-rear direction, a side where the modular plug 2 is inserted into the modular jack 1 is defined as a front side, and the opposite side is defined as a rear side.

The plug body 4 has a substantially rectangular parallelepiped shape and is attached to a distal end portion of the cable 3. The cable 3 is inserted into the plug body 4 through a front wall of the plug body 4. A plurality of grooves 7 opened outward are formed at a corner portion between a bottom wall of the plug body 4 and a rear wall of the plug body 4. In the illustrated example, the plug body 4 includes eight grooves 7. The plurality of grooves 7 are arranged side by side in the left-right direction. A plate-shaped mating contact 5 is provided in each groove 7. In a state where the mating contact 5 is provided in each groove 7, the mating contact 5 is exposed to the outside through an opening of the groove 7.

A lock lever 6 is provided at a rear end portion of the plug body 4. In the illustrated example, the lock lever 6 includes a latch portion 8 provided on the plug body 4 and a lever portion 9 provided on the latch portion 8. The latch portion 8 includes a mounting piece 10 and an extending piece 11. The mounting piece 10 has a substantially rectangular block shape and is located at a rear side of the latch portion 8. A substantially rectangular plate-shaped extending piece 11 is provided on the mounting piece 10. The extending piece 11 has a bifurcated shape opened forward and extends obliquely upward and forward from the mounting piece 10. The extending piece 11 is elastically deformable so as to pivot downward around a rear end portion provided on the mounting piece 10. The vertical length of the bifurcated portion of the extending piece 11 increases from the rear end portion toward the front end portion. A front surface of the bifurcated portion of the extending piece 11 is a front surface of the latch portion 8 and serves as a latch surface 12 that can latch to a shell 15 described later. A substantially rectangular plate-shaped lever portion 9 is provided on the extending piece 11 of the latch portion 8. The lever portion 9 extends obliquely upward and forward from the latch portion 8. The lever portion 9 is located between the bifurcated portions of the extending piece 11, extending farther forward than the front surface of the latch portion 8.

The lock lever 6 with such a configuration is provided on the plug body 4. Specifically, by fixing the mounting piece 10 to the rear end portion of the plug body 4, the lock lever 6 is provided on the plug body 4. In a state where the lock lever 6 is provided on the plug body 4, the extending piece 11 and the lever portion 9 extend obliquely upward and forward from the mounting piece 10 and are located above the plug body 4. Gaps are formed between the extending piece 11 and the plug body 4, and between the lever portion 9 and the plug body 4. Accordingly, the latch portion 8 can be elastically deformed so as to pivot toward the plug body 4 around the rear end portion provided on the plug body 4. The lever portion 9 is provided on the latch portion 8 as described above, thus can pivot together with the latch portion 8.

In a state where the lock lever 6 is attached to the plug body 4, the lock lever 6 can be elastically deformed so as to pivot toward the plug body 4 around the rear end portion provided on the plug body 4. Specifically, when the lever portion 9 is pressed downward, the lock lever 6 is elastically deformed to pivot downward due to the above-described configuration. When the operation of the lever portion 9 is released after the lock lever 6 has been pivoted, the lock lever 6 automatically returns to its original position by spring force that causes itself to snap upward.

In the first embodiment, the mounting piece 10 and the extending piece 11 may be integrally formed or may be separate members. The latch portion 8 and the lever portion 9 may be integrally formed or may be separate members. The lock lever 6 and the plug body 4 may be integrally formed or may be separate members.

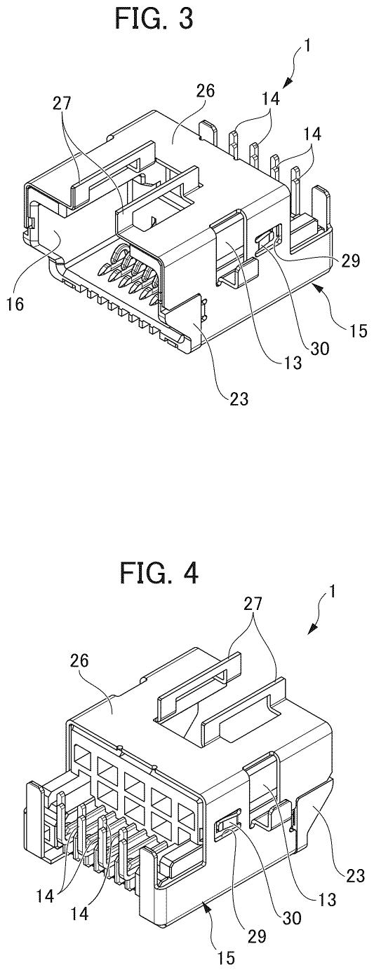

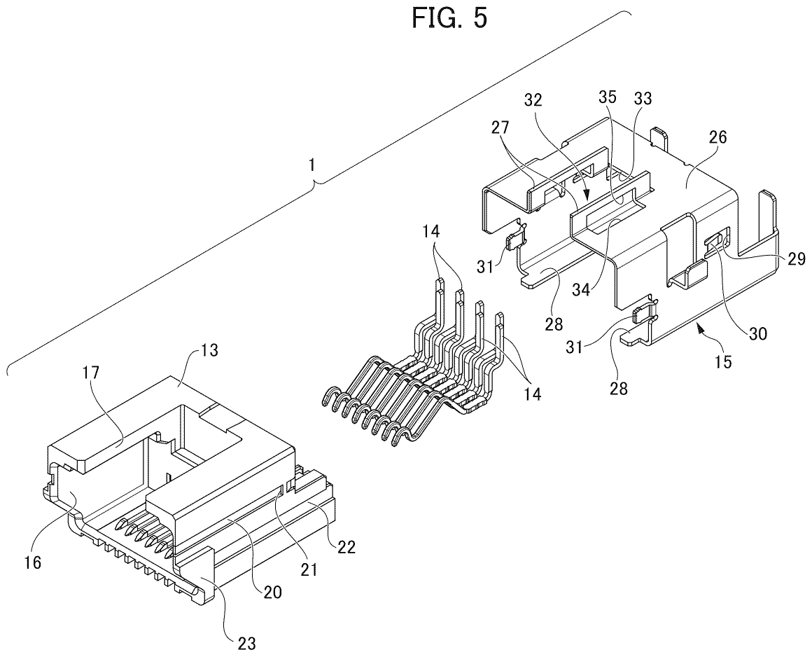

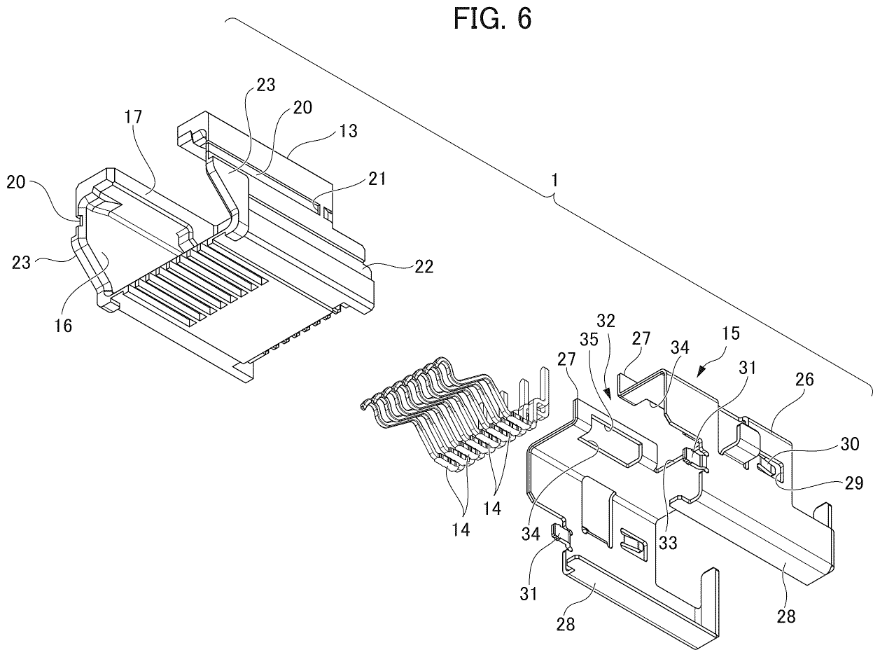

As illustrated in FIGS. 1 to 6, the modular jack 1 according to the first embodiment includes a housing 13 into which the modular plug 2 is inserted, a plurality of contacts 14 provided on the housing 13, and a shell 15 that covers the housing 13. As described above, the modular jack 1 is connected to the modular plug 2 of a LAN cable. In this case, the modular jack 1 is typically mounted in an electronic device such as a notebook computer.

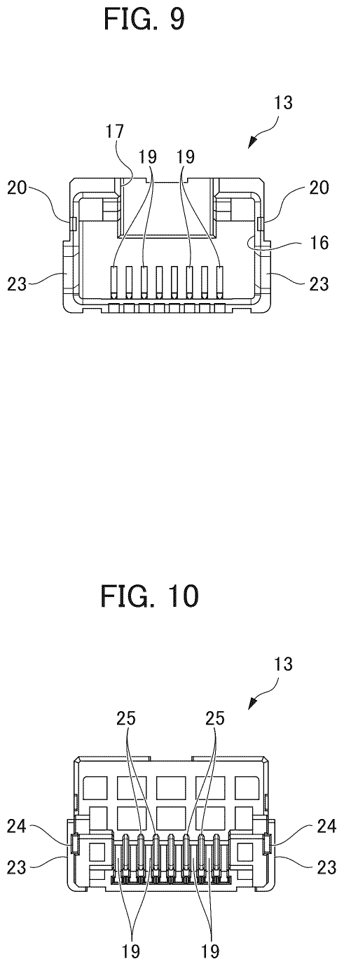

As illustrated in FIGS. 1 to 6 and FIGS. 9 to 11, the housing 13 has a substantially rectangular block shape and includes a plug accommodating recess 16 that is opened forward. The housing 13 is, for example, a rectangular tubular member opened forward. A notch-shaped lever insertion hole 17 opened forward is formed in an upper wall of the housing 13. The lever insertion hole 17 penetrates the upper wall of the housing 13 in the vertical direction. A plurality of through holes 18 are formed in a lower wall of the housing 13. In the illustrated example, the lower wall of the housing 13 includes eight through holes 18. Each through hole 18 has a substantially rectangular shape extending in the front-rear direction and penetrates the lower wall of the housing 13 in the vertical direction. The plurality of through holes 18 are arranged side by side in the left-right direction. A plurality of contact insertion holes 19 are formed in a rear wall of the housing 13. In the illustrated example, the rear wall of the housing 13 includes eight contact insertion holes 19. Each contact insertion hole 19 penetrates the rear wall of the housing 13 in the front-rear direction. The plurality of contact insertion holes 19 are arranged side by side in the left-right direction.

A groove-shaped first recess 20 opened outward is formed in each of a left wall of the housing 13 and a right wall of the housing 13. The first recess 20 of the left wall of the housing 13 has a substantially rectangular groove shape opened leftward and extends in the front-rear direction. A rear end portion of the first recess 20 of the left wall of the housing 13 is closed. That is, the first recess 20 includes an inner surface 21 located on a rear side. A front end portion of the first recess 20 of the left wall of the housing 13 is opened forward. The first recess 20 of the right wall of the housing 13 has a substantially rectangular groove shape opened rightward and extends in the front-rear direction. A rear end portion of the first recess 20 of the right wall of the housing 13 is closed. That is, the first recess 20 includes an inner surface 21 located on a rear side. A front end portion of the first recess 20 of the right wall of the housing 13 is opened forward.

A groove-shaped second recess 22 opened outward is formed in each of a left wall of the housing 13 and a right wall of the housing 13. The second recess 22 of the left wall of the housing 13 has a substantially rectangular groove shape opened leftward and extends in the front-rear direction. A front end portion of the second recess 22 of the left wall of the housing 13 is closed by a bulged portion 23 formed on the left wall of the housing 13. The bulged portion 23 protrudes leftward from the left wall of the housing 13. An insertion hole 24 opened rearward is formed in the bulged portion 23. The insertion hole 24 communicates with the second recess 22 of the left wall of the housing 13. That is, a front end portion of an inner surface of the second recess 22 constitutes part of an inner surface of the insertion hole 24. A rear end portion of the second recess 22 of the left wall of the housing 13 is opened rearward. The second recess 22 of the right wall of the housing 13 has a substantially rectangular groove shape opened rightward and extends in the front-rear direction. A front end portion of the second recess 22 of the right wall of the housing 13 is closed by a bulged portion 23 formed on the right wall of the housing 13. The bulged portion 23 protrudes rightward from the right wall of the housing 13. An insertion hole 24 opened rearward is formed in the bulged portion 23. The insertion hole 24 communicates with the second recess 22 of the right wall of the housing 13. That is, a front end portion of an inner surface of the second recess 22 constitutes part of an inner surface of the insertion hole 24. A rear end portion of the second recess 22 of the right wall of the housing 13 is opened rearward.

A lower wall of the housing 13 extends rearward beyond a rear wall of the housing 13, and a plurality of partition plates 25 are provided on the extended portion. Each partition plate 25 has a substantially rectangular plate shape and stands upright on the lower wall of the housing 13. The plurality of partition plates 25 are arranged side by side in the left-right direction. Each contact insertion hole 19 formed in the rear wall of the housing 13 is positioned between adjacent partition plates 25 and 25. The lower portion of the left wall of the housing 13 and the lower portion of the right wall of the housing 13 extend rearward beyond the rear wall of the housing 13. The upper portion of the left wall of the housing 13 and the upper portion of the right wall the housing 13 are provided with the above-described first recesses 20; and the lower portion of the left wall of the housing 13 and the lower portion of the right wall the housing 13 are provided with the above-described second recesses 22.

As illustrated in FIGS. 1 to 6, each contact 14 has an elongated plate shape extending in the front-rear direction and is formed by bending a plate material. In the illustrated example, the modular jack 1 includes eight contacts 14. Each contact 14 is mounted on the lower wall of the housing 13 in a state of penetrating the contact insertion hole 19 formed in the rear wall of the housing 13. In a state where the contact 14 is mounted on the housing 13, a front portion of the contact 14 is located within the plug accommodating recess 16 of the housing 13 and is exposed to the outside through the through hole 18 formed in the lower wall of the housing 13. In the state where the contact 14 is mounted on the housing 13, a rear portion of the contact 14 protrudes rearward from the rear wall of the housing 13 and is located between adjacent partition plates 25 and 25. The plurality of contacts 14 are arranged side by side in the left-right direction. Thus, a plurality of contacts 14 are provided in the housing 13.

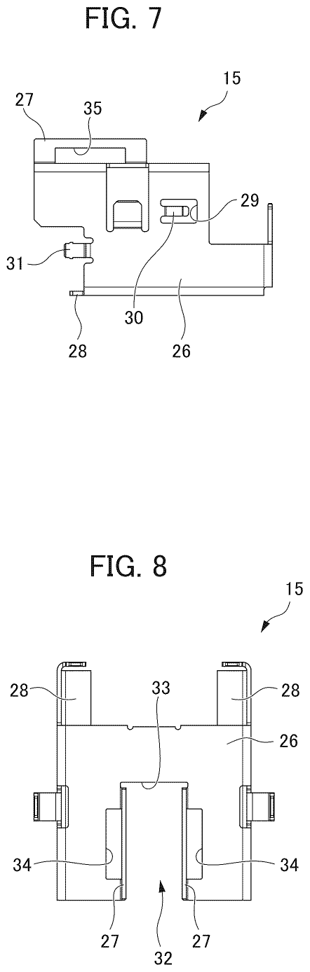

As illustrated in FIGS. 1 to 8, the shell 15 has a substantially rectangular groove shape opened downward and extends in the front-rear direction. A front end portion of the shell 15 is opened forward, and a rear end portion of the shell 15 is opened rearward. In a state where the modular plug 2 is connected to the modular jack 1, the latch portion 8 of the lock lever 6 can latch to the shell 15. In the illustrated example, the shell 15 is made of metal and includes a shell body 26 that covers the housing 13, and an anti-lift portion 27 provided on the shell body 26.

The shell body 26 has a substantially rectangular groove shape opened downward and extends in the front-rear direction. A front end portion of the shell body 26 is opened forward, and a rear end portion of the shell body 26 is opened rearward. A lower portion of a left wall of the shell body 26 extends farther rearward than an upper portion of the left wall of the shell body 26. A rear end portion of the lower portion of the left wall of the shell body 26 is bent inward. A front end portion of the lower portion of the left wall of the shell body 26 is located rearward of a front end portion of the upper portion of the left wall of the shell body 26. A lower portion of a right wall of the shell body 26 extends farther rearward than an upper portion of the right wall of the shell body 26. A rear end portion of the lower portion of the right wall of the shell body 26 is bent inward. A front end portion of the lower portion of the right wall of the shell body 26 is located rearward of a front end portion of the upper portion of the right wall of the shell body 26. A lower end portion of the left wall of the shell body 26 and a lower end portion of the right wall of the shell body 26 are bent inward. Accordingly, a mounting portion 28 for the housing 13 is formed at the lower end portion of the left wall of the shell body 26 and the lower end portion of the right wall of the shell body 26.

Through holes 29 and claw portions 30 are formed in the left wall of the shell body 26 and the right wall of the shell body 26. A through hole 29 having a substantially rectangular shape in a side view is formed at a rear end portion of an upper portion of the left wall of the shell body 26. The through hole 29 penetrates the left wall of the shell body 26 in the left-right direction. A claw portion 30 is formed on an inner surface of the through hole 29. The claw portion 30 has a plate shape and extends obliquely rearward from a front end portion of the inner surface of the through hole 29 and inward to the inner side of the shell body 26. Similarly, a through hole 29 having a substantially rectangular shape in a side view is formed at a rear end portion of an upper portion of the right wall of the shell body 26. The through hole 29 penetrates the right wall of the shell body 26 in the left- right direction. A claw portion 30 is formed on an inner surface of the through hole 29. The claw portion 30 has a plate shape and extends obliquely rearward from a front end portion of the inner surface of the through hole 29 and inward to the inner side of the shell body 26. Insertion pieces 31 to be inserted into the insertion holes 24 provided in the housing 13 are formed on the left wall of the shell body 26 and the right wall of the shell body 26. An insertion piece 31 is formed at a front end portion of a lower portion of the left wall of the shell body 26. The insertion piece 31 has a plate shape and extends forward from the front end portion of the lower portion of the left wall of the shell body 26. An insertion piece 31 is formed at a front end portion of a lower portion of the right wall of the shell body 26. The insertion piece 31 has a plate shape and extends forward from the front end portion of the lower portion of the right wall of the shell body 26.

The shell body 26 includes a hole portion 32 through which the latch portion 8 and the lever portion 9 protrude outward from the shell body 26. The hole portion 32 has a notch shape opened forward and is formed in an upper wall of the shell body 26. The hole portion 32 has a substantially rectangular shape in a plan view and penetrates the upper wall of the shell body 26 in the vertical direction. In the illustrated example, the hole portion 32 includes a first hole portion 33 through which the lever portion 9 protrudes, and a pair of second hole portions 34, 34 through which the latch portion 8 protrudes. The first hole portion 33 has a substantially rectangular notch shape in a plan view, extending in the front-rear direction, and opened forward. Of the pair of second hole portions 34, 34, one second hole portion 34 is located on the left side of the first hole portion 33, and the other second hole portion 34 is located on the right side of the first hole portion 33. The second hole portion 34 located on the left side and the second hole portion 34 located on the right side each have a substantially rectangular shape in a plan view, extending in the front-rear direction. The length of the second hole portion 34 in the front-rear direction is shorter than the length of the first hole portion 33 in the front-rear direction. The second hole portion 34 located on the left side and the second hole portion 34 located on the right side are continuous with the first hole portion 33. That is, the second hole portion 34 located on the left side projects leftward from the first hole portion 33, and the second hole portion 34 located on the right side projects rightward from the first hole portion 33.

The shell body 26 is provided with a pair of left and right anti-lift portions 27, 27 configured to restrict the latch portion 8 and the lever portion 9 from protruding outward more than necessary. In the illustrated example, each anti-lift portion 27 has a plate shape extending in the front- rear direction and stands upright on the upper wall of the shell body 26. Of the pair of anti-lift portions 27, 27, an anti-lift portion 27 located on the left side is provided so as to bridge between a portion of the upper wall of the shell body 26 located in front of the second hole portion 34 and a portion of the upper wall of the shell body 26 located behind the second hole portion 34. The anti-lift portion 27 located on the left side includes a notch-shaped contact portion 35 opened downward toward the hole portion 32. Of the pair of anti-lift portions 27, 27, an anti-lift portion 27 located on the right side is provided so as to bridge between a portion of the upper wall of the shell body 26 located in front of the second hole portion 34 and a portion of the upper wall of the shell body 26 located behind the second hole portion 34. The anti-lift portion 27 located on the right side also includes a notch-shaped contact portion 35 opened downward toward the hole portion 32. Thus, the anti-lift portions 27 are disposed so as to extend across the hole portion 32. In the illustrated example, each anti-lift portion 27 is formed by bending a part of the shell body 26 upward, but the invention is not limited thereto, and each anti-lift portion 27 may be a separate member from the shell body 26.

The shell 15 is provided on the housing 13 so as to cover an outer surface of the housing 13. In the illustrated example, the housing 13 is inserted into the shell 15 so that the shell 15 is attached to the housing 13. When attaching the shell 15 to the housing 13, first, a rear end portion of a lower wall of the housing 13 is placed on the mounting portion 28 of the shell 15. In the state where the rear end portion of the housing 13 is placed on the mounting portion 28 of the shell 15, a insertion piece 31 located on the left side is inserted into a front end portion of the second recess 22 located on the left side, and the insertion piece 31 located on the right side is inserted into a front end portion of the second recess 22 located on the right side.

In the state where the rear end portion of the housing 13 is placed on the mounting portion 28 of the shell 15, the shell 15 is moved forward relative to the housing 13. As a result, the insertion piece 31 located on the left side moves forward within the second recess 22 located on the left side and is then inserted into the insertion hole 24 located on the left side, while the insertion piece 31 located on the right side moves forward within the second recess 22 located on the right side and is then inserted into the insertion hole 24 located on the right side. When the shell 15 is moved forward relative to the housing 13, the claw portion 30 located on the left side elastically deforms and rides over a rear end portion of the left wall of the housing 13, and then is inserted into the first recess 20 located on the left side, and the claw portion 30 located on the right side elastically deforms and rides over a rear end portion of the right wall of the housing 13, and then is inserted into the first recess 20 located on the right side.

In this manner, by moving the shell 15 forward relative to the housing 13, the shell 15 is attached to the exterior of the housing 13. In the state where the shell 15 is attached to the housing 13, the hole portion 32 of the shell 15 is positioned above the lever insertion hole 17 formed in the upper wall of the housing 13. In the state where the shell 15 is attached to the housing 13, when an attempt is made to move the housing 13 forward relative to the shell 15, the claw portion 30 located on the left side comes into contact with the inner surface 21 located on the rear side of the first recess 20 located on the left side, and the claw portion 30 located on the right side comes into contact with the inner surface 21 located on the rear side of the first recess 20 located on the right side. Accordingly, detachment of the housing 13 from the shell 15 can be prevented. Alternatively, the shell 15 may be attached to the housing 13 by moving the housing 13 rearward relative to the shell 15.

As described above, the modular jack 1 is assembled by providing the plurality of contacts 14 on the housing 13 and attaching the shell 15 to the housing 13. As previously described, the modular plug 2 is connected to the modular jack 1. When connecting the modular plug 2 to the modular jack 1, the plug body 4 is simply inserted into the plug accommodating recess 16 of the housing 13. In a state where the modular plug 2 is connected to the modular jack 1, the mating contacts 5 of the modular plug 2 are in contact with the contacts 14 of the modular jack 1. Accordingly, the contacts 14 of the modular jack 1 are electrically connected to the mating contacts 5 of the modular plug 2.

When the plug body 4 is inserted into the plug accommodating recess 16, the lock lever 6 is inserted forward into the lever insertion hole 17 formed in the upper wall of the housing 13. As the plug body 4 is inserted into the plug accommodating recess 16, the lever portion 9 is inserted forward into the first hole portion 33 of the hole portion 32 formed in the upper wall of the shell 15. As the plug body 4 is inserted into the plug accommodating recess 16, the extending piece 11 of the latch portion 8 comes into contact with the upper wall of the shell body 26, passes beneath the upper wall of the shell body 26 while maintaining contact therewith, and then reaches the second hole portion 34. The extending piece 11 of the latch portion 8 is in contact with the upper wall of the shell body 26, thereby elastically deforming and pivoting downward together with the lever portion 9 so as to approach the plug body 4. The extending piece 11 of the latch portion 8 remains elastically deformed downward while being in contact with the upper wall of the shell body 26. The extending piece 11 of the latch portion 8 reaches the second hole portion 34, and pivots upward, away from the plug body 4, by spring force.

When the extending piece 11 of the latch portion 8 pivots upward, a part of a distal end portion of the extending piece 11 of the latch portion 8 projects upward through the second hole portion 34. At this time, the distal end portion of the extending piece 11 of the latch portion 8 is not in contact with the anti-lift portion 27. Specifically, a gap 36 is formed between the distal end portion of the extending piece 11 of the latch portion 8 and an upper inner surface of the contact portion 35 of the anti-lift portion 27. A vertical length, corresponding to a depth of the notch-shaped contact portion 35 of the anti-lift portion 27, is greater than a projecting length of the distal end portion of the extending piece 11 of the latch portion 8 when the distal end portion projects through the second hole portion 34. In the state where the distal end portion of the extending piece 11 of the latch portion 8 is not in contact with the anti-lift portion 27, the latch portion 8 can latch to the anti-lift portion 27. That is, in the state where the distal end portion of the extending piece 11 of the latch portion 8 is not in contact with the anti-lift portion 27, the latch surface 12 of the extending piece 11 of the latch portion 8 faces a front inner surface of the contact portion 35 of the anti-lift portion 27 while being spaced apart therefrom in the front-rear direction. Accordingly, the anti-lift portion 27 restricts upward pivoting of the lock lever 6 away from the plug body 4 while maintaining a state in which the lock lever 6 can latch to the shell 15.

In this manner, the modular plug 2 inserted into the modular jack 1 can be removed from the modular jack 1 by operating the lock lever 6. To pull the modular plug 2 out from the modular jack 1, the lever portion 9 is pressed downward to pivot the lock lever 6 downward, and then the modular plug 2 is moved forward. When the lock lever 6 is pivoted downward, the extending piece 11 of the latch portion 8 moves to a position below the upper wall of the shell body 26. In this state, by moving the modular plug 2 forward, the modular plug 2 can be withdrawn from the modular jack 1.

When an attempt is made to pull the modular plug 2 out from the modular jack 1 without operating the lock lever 6, the latch surface 12 of the extending piece 11 of the latch portion 8 comes into contact with a front inner surface of the contact portion 35 of the anti-lift portion 27, while the extending piece 11 of the latch portion 8 pivots upward. As soon as the extending piece 11 of the latch portion 8 starts to pivot upward, the distal end portion of the extending piece 11 of the latch portion 8 comes into contact with an upper inner surface of the contact portion 35 of the anti-lift portion 27. Accordingly, in the state where the distal end portion of the extending piece 11 of the latch portion 8 is in contact with the upper inner surface of the contact portion 35 of the anti-lift portion 27, the latch surface 12 of the extending piece 11 of the latch portion 8 is in contact with the front inner surface of the contact portion 35 of the anti-lift portion 27. That is, the latch portion 8 is latched to the anti-lift portion 27. In this manner, the anti-lift portion 27 can prevent the upper wall of the shell body 26 from entering between the extending piece 11 of the latch portion 8 and the plug body 4, thereby preventing a state in which the latch portion 8 becomes unable to latch to the shell 15. Therefore, the anti-lift portion 27 can prevent the latch portion 8 from pivoting upward away from the plug body 4 to an extent that the latch portion 8 becomes unable to latch to the shell 15. In the state where the latch portion 8 can latch to the shell 15, the anti-lift portion 27 is not in contact with the latch portion 8. When the extending piece 11 of the latch portion 8 pivots upward from this state and the latch portion 8 comes into contact with the anti-lift portion 27, the latch portion 8 can be prevented from pivoting upward away from the plug body 4 to an extent that the latch portion 8 becomes unable to latch to the shell 15.

When an attempt is made to pull the modular plug 2 out from the modular jack 1 without operating the lock lever 6, the latch portion 8 is latched to the shell 15. In the illustrated example, the latch surface 12 of the extending piece 11 of the latch portion 8 comes into contact with a front inner surface of the contact portion 35 of the anti-lift portion 27. Accordingly, since the lock lever 6 is latched to the shell 15, the modular plug 2 inserted into the housing 13 cannot be detached from the housing 13.

In the modular jack 1 of the first embodiment, the shell 15 includes the anti-lift portion 27 configured to restrict the lock lever 6 from pivoting away from the plug body 4 more than necessary from its original position before elastic deformation, in the state where the modular plug 2 is connected to the modular jack 1. This prevents the lock lever 6 from becoming inoperable. Accordingly, according to the modular jack 1 of the first embodiment, a simple structure can prevent the modular plug 2 from becoming undetachable from the modular jack 1.

In the modular jack 1 of the first embodiment, the anti-lift portion 27 provided on the shell 15 can prevent the lock lever 6 from pivoting upward. Accordingly, compared to a case where the upward pivoting of the lock lever 6 is prevented by a member provided on an electronic device to which the modular jack is mounted, the modular jack 1 of the first embodiment is not affected by assembly position accuracy.

In the modular jack 1 of the first embodiment, the anti-lift portion 27 is disposed so as to extend across the hole portion 32. Accordingly, according to the modular jack 1 of the first embodiment, the anti-lift portion 27 can have a simpler structure.

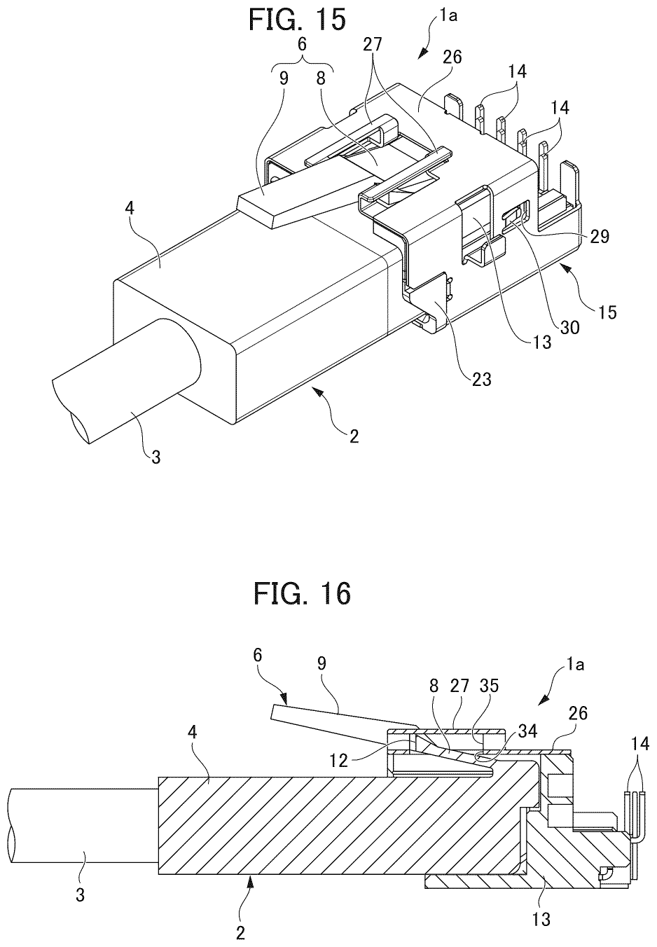

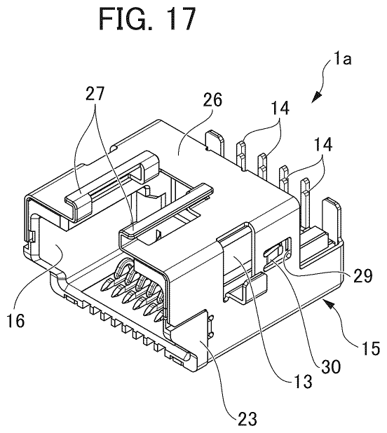

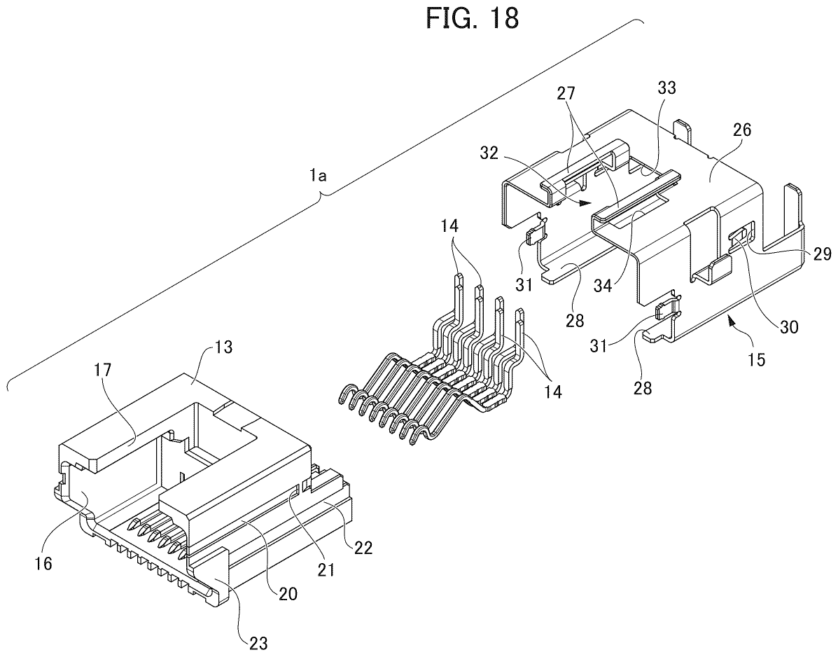

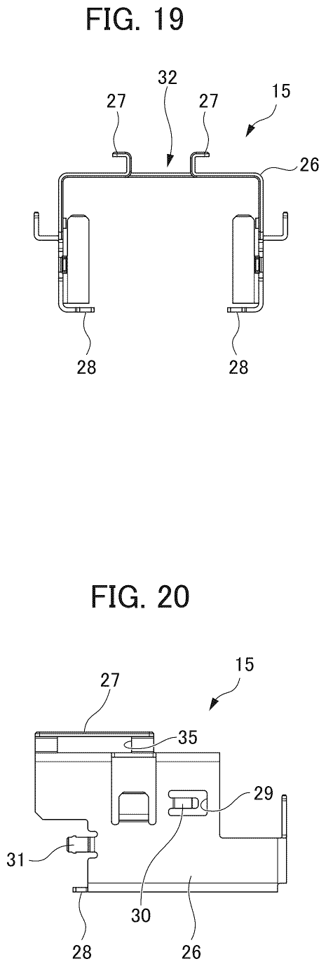

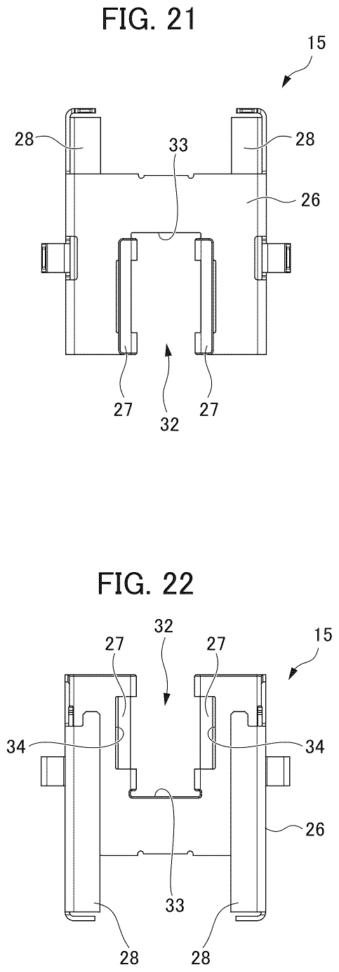

Next, with reference to FIGS. 15 to 22, a modular jack 1a according to a second embodiment of the present invention will be described. It should be noted that components having the same reference numerals as those in the above embodiment perform the same functions, and thus their detailed descriptions may be omitted. The modular jack 1a according to the second embodiment differs from the first embodiment in the configuration of the anti-lift portion 27.

Of the pair of left and right anti-lift portions 27, 27, the anti-lift portion 27 located on the left side has a plate shape extending in the front-rear direction and stands upright on the upper wall of the shell body 26 so as to extend across the hole portion 32 in the front-rear direction. In the illustrated example, the anti-lift portion 27 located on the left side is formed by bending a part of the shell body 26 upward. An upper end portion of the anti-lift portion 27 located on the left side is bent outward. In the illustrated example, the upper end portion of the anti-lift portion 27 located on the left side is bent substantially at a right angle toward the left. Accordingly, an upper end portion of the contact portion 35 of the anti-lift portion 27 located on the left side is bent leftward. That is, an upper inner surface of the contact portion 35 of the anti-lift portion 27 located on the left side faces inward, that is, rightward. The anti-lift portion 27 located on the right side also has a plate shape extending in the front-rear direction and stands upright on the upper wall of the shell body 26 so as to extend across the hole portion 32 in the front-rear direction. In the illustrated example, the anti-lift portion 27 located on the right side is formed by bending a part of the shell body 26 upward. An upper end portion of the anti-lift portion 27 located on the right side is bent outward. In the illustrated example, the upper end portion of the anti-lift portion 27 located on the right side is bent substantially at a right angle toward the right. Accordingly, an upper end portion of the contact portion 35 of the anti-lift portion 27 located on the right side is bent rightward. That is, an upper inner surface of the contact portion 35 of the anti-lift portion 27 located on the right side faces inward, that is, leftward.

In the modular jack 1a according to the second embodiment, in a state where the modular plug 2 is inserted into the modular jack 1a, the extending piece 11 of the latch portion 8 protrudes outward through the second hole portion 34. An upper end portion of the bent anti-lift portion 27 is positioned above the second hole portion 34. Accordingly, the upper end portion of the anti-lift portion 27 is positioned above the extending piece 11 of the latch portion 8. A gap is formed between the upper end portion of the anti-lift portion 27 and a distal end portion of the extending piece 11 of the latch portion 8. With such a configuration, when the distal end portion of the extending piece 11 of the latch portion 8 comes into contact with the upper end portion of the anti-lift portion 27, the extending piece 11 of the latch portion 8 can be prevented from pivoting upward.

In the modular jack 1a of the second embodiment, upper end portions of the anti-lift portions 27 are bent outward. Accordingly, according to the modular jack 1a of the second embodiment, the vertical length of the shell 15 can be reduced, thereby allowing the modular jack 1a to be made more compact.

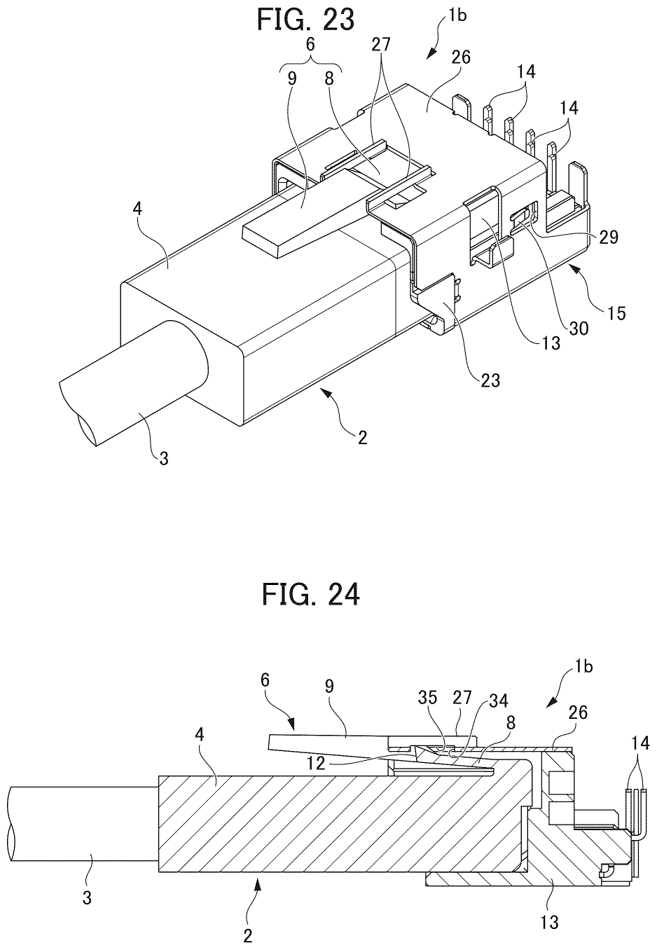

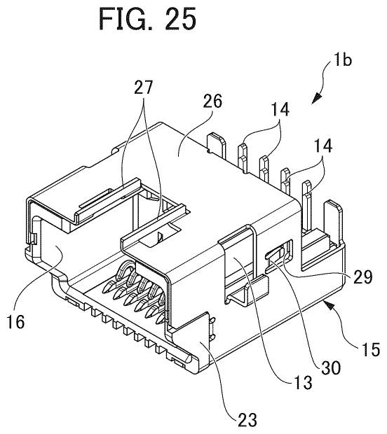

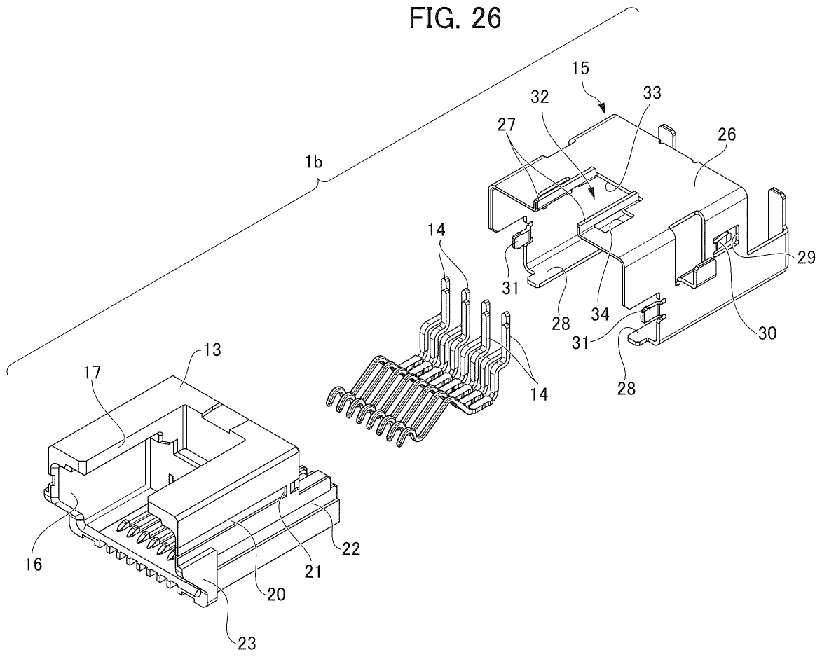

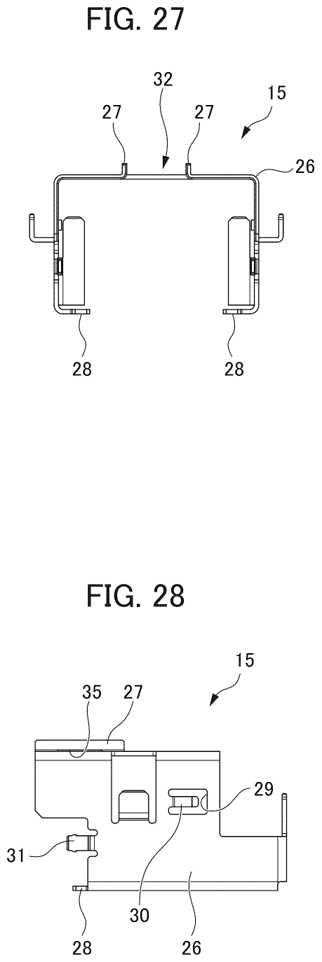

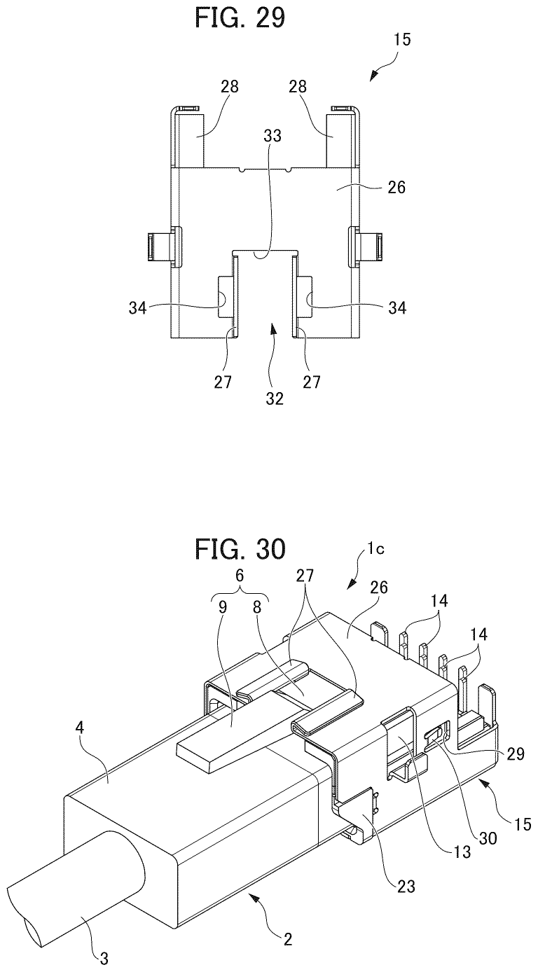

Next, with reference to FIGS. 23 to 29, a modular jack 1b according to a third embodiment of the present invention will be described. It should be noted that components having the same reference numerals as those in the above embodiments perform the same functions, and thus their detailed descriptions may be omitted. The modular jack 1b according to the third embodiment differs from the first embodiment in the configuration of the anti-lift portion 27.

Of the pair of left and right anti-lift portions 27, 27, the anti-lift portion 27 located on the left side has a plate shape extending in the front-rear direction and stands upright on the upper wall of the shell body 26. The anti-lift portion 27 located on the left side is provided so as to bridge between a portion of the upper wall of the shell body 26 located in front of the second hole portion 34 and a portion of the upper wall of the shell body 26 located behind the second hole portion 34. The anti-lift portion 27 located on the left side includes a notch-shaped contact portion 35 opened downward toward the hole portion 32. A vertical length of the anti-lift portion 27 located on the left side is smaller than a vertical length of the anti-lift portion 27 located on the left side in the first embodiment. A vertical length of the contact portion 35 of the anti-lift portion 27 located on the left side is also smaller than a vertical length of the contact portion 35 of the anti-lift portion 27 located on the left side in the first embodiment. Of the pair of left and right anti-lift portions 27, 27, the anti-lift portion 27 located on the right side is provided so as to bridge between a portion of the upper wall of the shell body 26 located in front of the second hole portion 34 and a portion of the upper wall of the shell body 26 located behind the second hole portion 34. The anti-lift portion 27 located on the right side includes a notch-shaped contact portion 35 opened downward toward the hole portion 32. A vertical length of the anti-lift portion 27 located on the right side is smaller than a vertical length of the anti-lift portion located on the right side in the first embodiment. A vertical length of the contact portion 35 of the anti-lift portion 27 located on the right side is also smaller than a vertical length of the contact portion 35 of the anti-lift portion 27 located on the right side in the first embodiment.

Thus, the anti-lift portions 27 are disposed so as to extend across the hole portion 32. In the illustrated example, the anti-lift portion 27 is formed by bending a part of the shell body 26 upward, but the invention is not limited thereto, and the anti-lift portion 27 may be a separate member from the shell body 26.

In the modular jack 1b of the third embodiment, the shell 15 includes a shell body 26 including a hole portion 32 to which the latch portion 8 can be latched, and an anti-lift portion 27 provided on the shell body 26. In a state where the latch portion 8 of the lock lever 6 can latch to the hole portion 32, the hole portion 32 allows the latch portion 8 and the lever portion 9 to protrude outward. In a state where the modular plug 2 is connected to the modular jack 1b, a part of a distal end portion of the extending piece 11 of the latch portion 8 protrudes upward through the second hole portion 34. At this time, the distal end portion of the extending piece 11 of the latch portion 8 is in contact with the anti-lift portion 27. Specifically, the distal end portion of the extending piece 11 of the latch portion 8 is in contact with an upper inner surface of the notch-shaped contact portion 35 formed in the anti-lift portion 27. In the state where the distal end portion of the extending piece 11 of the latch portion 8 is in contact with the anti-lift portion 27, the extending piece 11 of the latch portion 8 protrudes upward from the second hole portion 34 to such an extent that the latch surface 12, which is a front end surface of the latch portion 8, can come into contact with a front inner surface of the second hole portion 34. That is, in the state where the distal end portion of the extending piece 11 of the latch portion 8 is in contact with the anti-lift portion 27, the latch surface 12 of the extending piece 11 of the latch portion 8 faces the front inner surface of the second hole portion 34 while being spaced apart therefrom in the front- rear direction. Accordingly, in a state where the latch portion 8 can latch to the shell 15, the latch portion 8 is in contact with the anti-lift portion 27 so as to prevent the latch portion 8 from pivoting away from the plug body 4.

In the modular jack 1b of the third embodiment, the anti-lift portion 27 can prevent the extending piece 11 of the latch portion 8 from riding over the upper wall of the shell body 26 when an attempt is made to pull the modular plug 2 out from the modular jack 1b without operating the lock lever 6. Thus, it is possible to prevent a part of the shell 15 from entering between the lock lever 6 and the plug body 4, and also prevent a part of the latch portion 8 from entering between the modular jack 1b and an electronic device to which the modular jack 1b is mounted. Accordingly, according to the modular jack 1b of the third embodiment, a simple structure can prevent the modular plug 2 from becoming undetachable from the modular jack 1b.

In the modular jack 1b of the third embodiment, the anti-lift portion 27 holds the lock lever 6 at a position closer to the plug body 4 than its original position before elastic deformation. That is, the lock lever 6 is in contact with the anti-lift portion 27 by spring force. Accordingly, according to the modular jack 1b of the third embodiment, in a state where the modular plug 2 is connected to the modular jack 1b, the height of the lock lever 6 can be reduced, thereby enabling the electronic device to which the modular jack 1b is mounted to be made more compact.

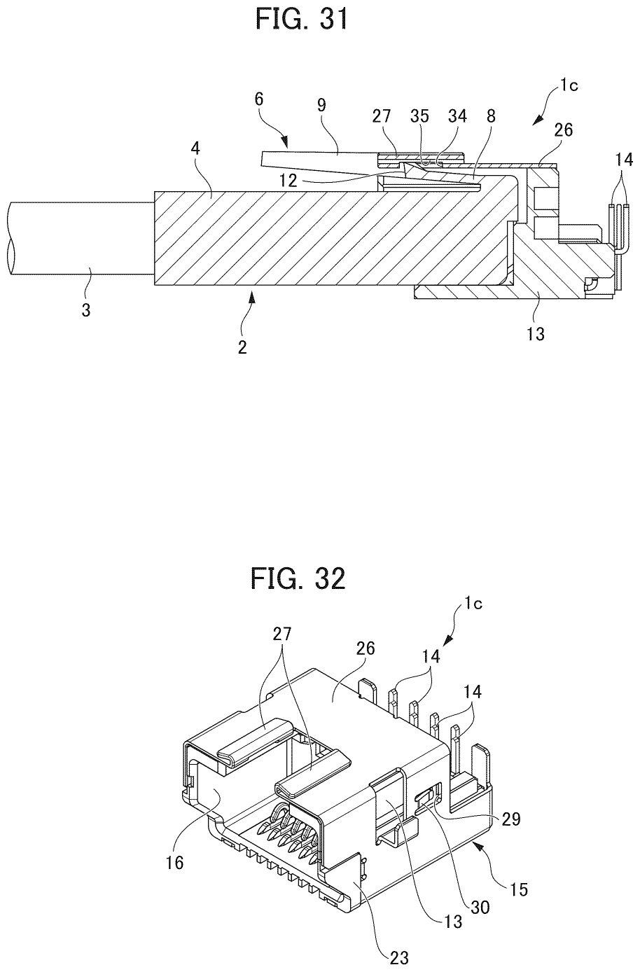

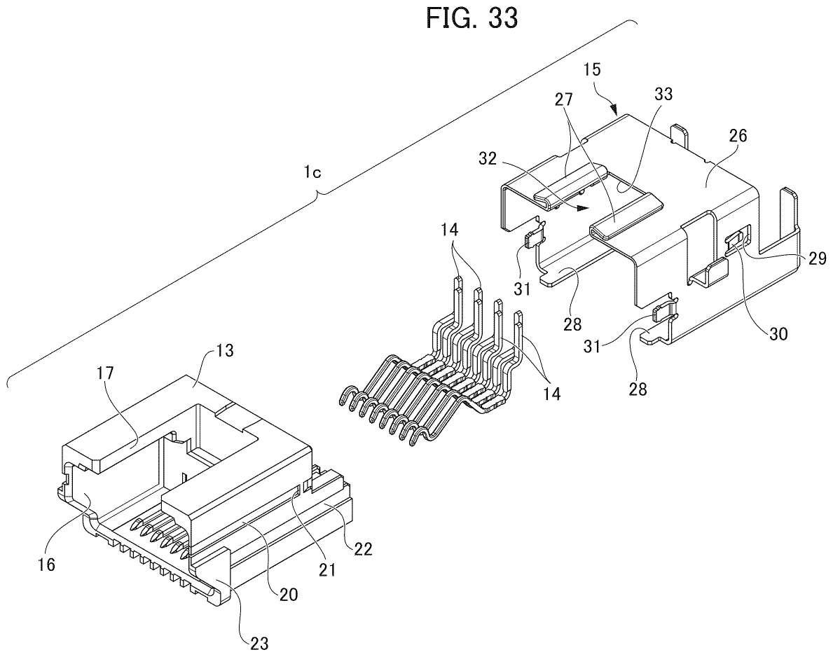

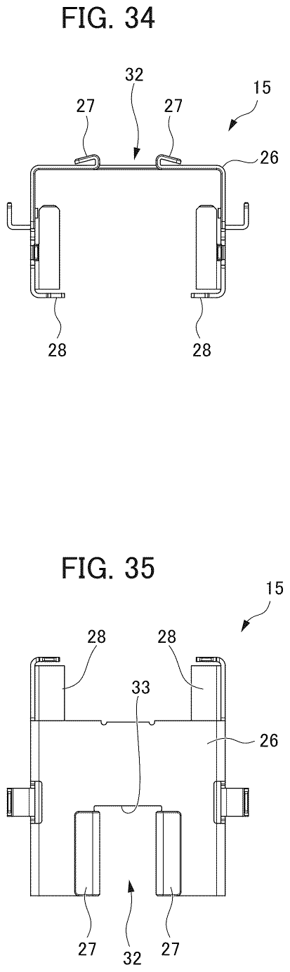

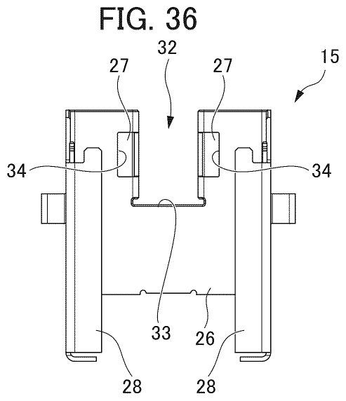

Next, with reference to FIGS. 30 to 36, a modular jack 1c according to a fourth embodiment of the present invention will be described. It should be noted that components having the same reference numerals as those in the above embodiments perform the same functions, and thus their detailed descriptions may be omitted. The modular jack 1c according to the fourth embodiment differs from the third embodiment in the configuration of the anti-lift portion 27. In the third embodiment, the anti-lift portion 27 was formed by bending a part of the shell body 26 upward, whereas in the fourth embodiment, the anti-lift portion 27 is formed by folding a part of the shell body 26 outward from an outer surface side of the shell body 26.

Of the pair of left and right anti-lift portions 27, 27, the anti-lift portion 27 located on the left side has a plate shape extending in the front-rear direction. Before being folded, the anti-lift portion 27 located on the left side connects a portion of the upper wall of the shell body 26 located in front of the second hole portion 34 and a portion of the upper wall of the shell body 26 located behind the second hole portion 34. The anti-lift portion 27 located on the left side is folded outward from the shell body 26. In the folded state, the anti-lift portion 27 located on the left side is positioned above the second hole portion 34 located on the left side. In the state where the anti-lift portion 27 located on the left side is folded, a vertical length of a gap between a distal end portion of the anti-lift portion 27 located on the left side and the upper wall of the shell body 26 is shorter than a vertical length of a gap between a base end portion of the anti-lift portion 27 located on the left side and the upper wall of the shell body 26. Accordingly, the anti-lift portion 27 located on the left side extends obliquely downward and leftward. The vertical length of the gap between the base end portion of the anti-lift portion 27 located on the left side and the upper wall of the shell body 26 is longer than a vertical length corresponding to a depth of the notch-shaped contact portion 35 located on the left side. Therefore, in the state where the anti-lift portion 27 located on the left side is folded, the contact portion 35 is opened downward toward the hole portion 32. Thus, the anti-lift portion 27 located on the left side is disposed so as to extend across the hole portion 32.

Of the pair of left and right anti-lift portions 27, 27, the anti-lift portion 27 located on the right side has a plate shape extending in the front-rear direction. Before being folded, the anti-lift portion 27 located on the right side connects a portion of the upper wall of the shell body 26 located in front of the second hole portion 34 and a portion of the upper wall of the shell body 26 located behind the second hole portion 34. The anti-lift portion 27 located on the right side is folded outward from the shell body 26. In the folded state, the anti-lift portion 27 located on the right side is positioned above the second hole portion 34 located on the right side. In the state where the anti-lift portion 27 located on the right side is folded, a vertical length of a gap between a distal end portion of the anti-lift portion 27 located on the right side and the upper wall of the shell body 26 is shorter than a vertical length of a gap between a base end portion of the anti-lift portion 27 located on the right side and the upper wall of the shell body 26. Accordingly, the anti-lift portion 27 located on the right side extends obliquely downward and rightward. The vertical length of the gap between the base end portion of the anti-lift portion 27 located on the right side and the upper wall of the shell body 26 is longer than a vertical length corresponding to a depth of the notch-shaped contact portion 35 located on the right side. Therefore, the state where the anti-lift portion 27 located on the right side is folded, the contact portion 35 is opened downward toward the hole portion 32. Thus, the anti-lift portion 27 located on the right side is disposed so as to extend across the hole portion 32.

In the modular jack 1c according to the fourth embodiment, in a state where the modular plug 2 is inserted into the modular jack 1c, the extending piece 11 of the latch portion 8 is in contact with an upper inner surface of the contact portion 35 of the anti-lift portion 27. In the state where the latch portion 8 is in contact with the anti-lift portion 27, a part of the extending piece 11 of the latch portion 8 protrudes upward beyond the upper wall of the shell body 26 through the second hole portion 34. Accordingly, the lock lever 6 is held at a position closer to the plug body 4 than its original position before elastic deformation.

In the modular jack 1c of the fourth embodiment, the anti-lift portion 27 has a plate shape formed by folding a part of the shell body 26 outward from an outer surface side of the shell body 26. Accordingly, according to the modular jack 1c of the fourth embodiment, the vertical length of the shell 15 can be reduced, thereby allowing the modular jack 1c to be made more compact. Furthermore, since the anti-lift portion 27 is folded outward, when the modular jack 1c is mounted on an electronic device such as a notebook computer, the anti-lift portion 27 does not rub against the electronic device. Therefore, no powdery residue is generated due to rubbing of the anti-lift portion 27 against the electronic device.

It should be noted that the present invention is not limited to the above-described embodiments, and various modifications and improvements can be made without departing from the scope of the invention as long as the object of the invention can be achieved.

For example, the configuration of the anti-lift portion 27 is not limited to those of the above embodiments. The anti-lift portion 27 may include any configuration as long as it can prevent the lock lever 6 from pivoting upward more than necessary.

In the first and second embodiments, the distal end portion of the extending piece 11 of the latch portion 8 may be in contact with the anti-lift portion 27. That is, in a state where the lock lever 6 is at its original position before elastic deformation, the distal end portion of the extending piece 11 of the latch portion 8 may be in contact with an upper inner surface of the contact portion 35 of the anti-lift portion 27.

In the above embodiments, the modular jacks 1, 1a, 1b, and 1c are arranged such that the lock lever 6 of the modular plug 2 is positioned upward when in use; however, the modular jacks may alternatively be arranged such that the lock lever 6 of the modular plug 2 is positioned downward when in use. That is, the modular jacks 1, 1a, 1b, and 1c may be used in an orientation inverted upside down relative to that of the above embodiments.

### EXPLANATION OF REFERENCE NUMERALS

1: modular jack
2: modular plug
3: cable
4: plug body
5: mating contact
8: latch portion
9: lever portion
13: housing
14: contact
15: shell
26: shell body
27: anti-lift portion
32: hole portion

What is claimed is:

1. A modular jack to which a modular plug is electrically connected, the modular plug including a plug body having a cable, a mating contact provided on the plug body, a latch portion elastically deformable so as to pivot toward the plug body around one end portion provided on the plug body, and a lever portion provided on the latch portion, the modular jack comprising:
a housing into which the modular plug is inserted;
a contact provided on the housing and connected to the mating contact; and
a shell provided on the housing so as to cover an outer surface of the housing, the shell being configured such that the latch portion can be latched thereto to prevent the modular plug inserted into the housing from being detached from the housing,
wherein the shell includes an anti-lift portion configured to prevent the latch portion from pivoting away from the plug body to an extent that the latch portion becomes unable to latch to the shell.

2. The modular jack according to claim 1,
wherein, in a state where the latch portion can latch to the shell, the latch portion is not in contact with the anti-lift portion, and
upon contact of the latch portion with the anti-lift portion, the latch portion is prevented from pivoting away from the plug body to an extent that the latch portion becomes unable to latch to the shell.

3. The modular jack according to claim 2,
wherein the shell includes a shell body having a hole portion that allows the latch portion and the lever portion to protrude outward, and the anti-lift portion provided on the shell body and configured such that the latch portion can be latched thereto, and
the anti-lift portion is disposed to extend across the hole portion.

4. The modular jack according to claim 1, wherein, in a state
where the latch portion can latch to the shell, the latch portion is in contact with the anti-lift portion to prevent the latch portion from pivoting away from the plug body.

5. The modular jack according to claim 4,
wherein the shell includes a shell body having a hole portion to which the latch portion can be latched, and the anti-lift portion provided on the shell body,
the hole portion allowing the latch portion and the lever portion to protrude outward, and
the anti-lift portion being disposed to extend across the hole portion.
